(19) United States
(12) Patent Application Publication
(10) Pub. No.: US 2007/0249207 A1
(43) Pub. Date: Oct. 25, 2007

(54) Electrical connector assembly

(75) Inventors: Hung-Yang Yeh, Tu-Cheng (TW); Hsiu-Yuan Hsu, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/789,140

(22) Filed: Apr. 24, 2007

(30) Foreign Application Priority Data
Apr. 24, 2006 (TW) 95206935

(51) Int. Cl. H01R 13/52

(52) U.S. Cl. 439/281

(57) ABSTRACT

An electrical connector assembly (1) comprises a housing (10), an operating member (11), a cover (12) pivotally engaged in one side of the housing (10), a shaft (14) for connecting the cover (12) to the housing (10) and a plurality of terminals (13). The operating member (11) defines a number of receiving holes (110), and the housing (10) defines a plurality of passageways (100) corresponding to the receiving holes (110). The terminal (13) comprises a contact engaging portion (131) received in the housing (10) for contacting with the chip module (2), an retaining portion (132) received in the received hole (110), a tail (1) connecting to the printed circuit board and a neck portion (134) connecting the retaining portion (132) and the contact engaging portion (131). The operating member (11) is floatably supported by a first projection (1341) formed on the first connecting portion (134).

### BACKGROUND OF THE INVENTION

1. Field of the Invention

The present invention relates to an electrical connector assembly, particularly to an electrical connector assembly for receiving chip modules therein.

2. Description of the Prior Art

A conventional electrical connector assembly as shown in U.S. Pat. No. 6,610,254 comprises contacting pins and the pins use spurs or tabs projecting from the implanted portion to assist in holding the contact in place and in reducing transmission of the stress to the solder tails on the interconnect end. The spurs provide additional points of contact with the inner wall surfaces of the apertures in the base member and provide balancing force to those being imposed by the package.

Another conventional electrical connector assembly 5′ for testing a retaining chip modules therein is disclosed in FIGS. 1-3. The electrical connector assembly 1′ comprises a housing 10′, an operating member 11′ and a cover 12′ pivotally engaged with a side of the housing 10′, and a shaft 14′ connecting the cover 12′ and the housing 10′, a plurality of terminals 13′ received in the housing 10′. The housing 10′ defines a number of passageways 110′ respectively for receiving the terminals 13′ therein and the operating member 11′ defines a number of receiving slots 110′ in correspondence with passageways 100′ of the housing 10′. The terminal 13′ comprises a contact engaging portion 131′ received in the passageways 100′, an retaining portion 132′ received in the receiving slot 110′, a tail 133′ connecting to the printed circuit board and a neck 134′ for connecting the connecting retaining 132′ and the contact engaging portion 131′. The chip module 2′ defines a plurality of solder balls 20′ for electrically engaging with the contact engaging portion 131′ of the terminals 13′.

In assembly, the cover 12′ is first opened and then put the chip module 2′ onto the operating member 11′. At this moment, the solder balls 20′ of the chip module 2′ are inserted into the passageways 100′ of the housing 10′. Sequentially, the cover 12′ is oriented to a horizontal position to locating on the housing 10′. The cover 12′ presses the chip module 2′ downwardly. At last, the solder balls 20′ of the housing 10′ are engaged with the contact engaging portion 131′ of the terminals 13′ received in the housing 10′ so that the electrical connection of the electrical connector assembly 1′ is attained.

However, the housing 10′ and the cover 12′ are conventional made of hard materials so that the tolerance between the housing 10 and the cover 12′ are limited. The terminals 13′ also have tolerance on manufacturing. When the operating member 11′ is pressed downwardly, protruding portions of the contact engaging portions 131′ extending outwardly from the housing 10′ are not uniformity. When the protruding portion is shorter than a predetermine length, the contact engaging portion 131′ is not engaged with the solder balls, hence the chip module 2′ not connecting with the terminals 13′. When the protruding portion is longer than the predetermine length, the contact engaging portion 13 scuffs the chip module.

Hence, an improved electrical connector bracket is required to overcome the disadvantages of the prior art.

### BRIEF SUMMARY OF THE INVENTION

An object of the present invention is to provide an electrical connector assembly able to maintain a well contact between the chip module and the terminals.

An electrical connector assembly in accordance with a preferred embodiment of the present invention comprises a housing, an operating member, a cover pivotally engaged in one side of the housing, a shaft for connecting the cover to the housing and a plurality of terminals. The operating member defines a number of passageways, and the housing defines a plurality of receiving holes corresponding to the passageways. The terminal comprises a contact engaging portion received in the housing, an retaining portion received in the received hole, a tail connecting to the printed circuit board and a first connecting portion connecting the retaining portion and the contact engaging portion. The operating member is floatably supported by a first projection formed on the first connecting portion.

Relative to the present technology, the electrical connector assembly in accordance with the invention defines a pair of first projection abutting against the bottom surface of the operating member which can control the protruding length of the contact engaging portion inserted into the passageways, hence the chip module and the terminals attains a good electrical connection.

Other objects, advantages and novel features of the invention will become more apparent from the following detailed description of a preferred embodiment when taken in conjunction with the accompanying drawings.

### BRIEF DESCRIPTION OF THE DRAWINGS

FIG. 1 is an isometric view of a conventional electrical connector assembly receiving a chip module therein;

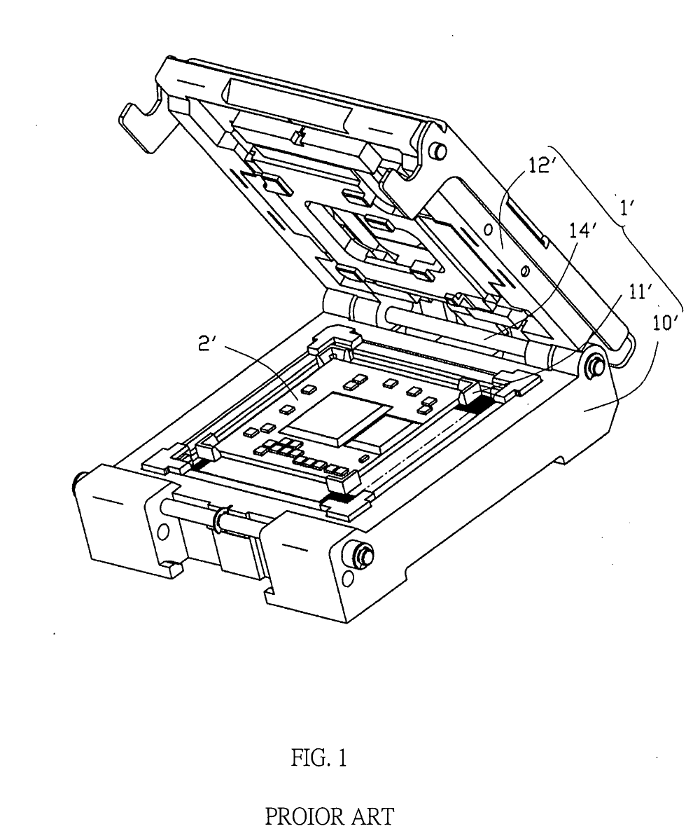

FIG. 2 is an isometric view of a terminal assembled in the electrical connector assembly shown in FIG. 1;

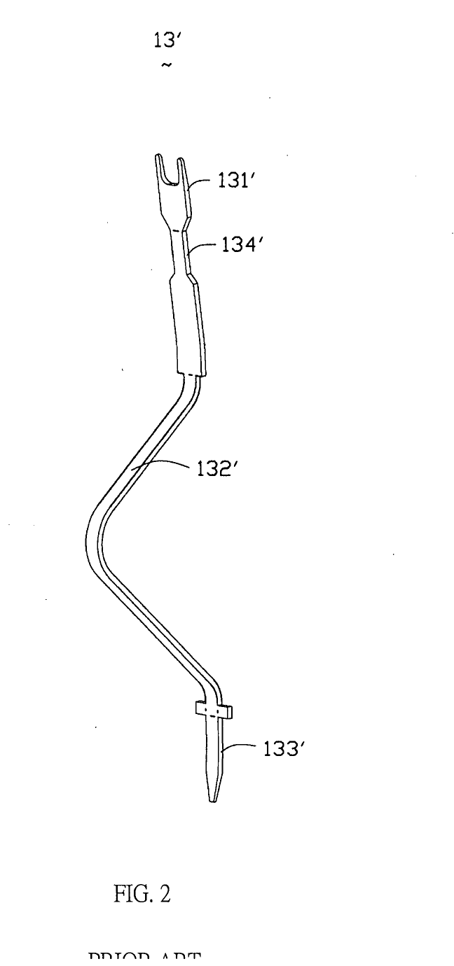

FIG. 3 is a perspective view of the electrical connector assembly shown in FIG. 1, wherein the contact engaging portion of the terminal contacts with the chip module;

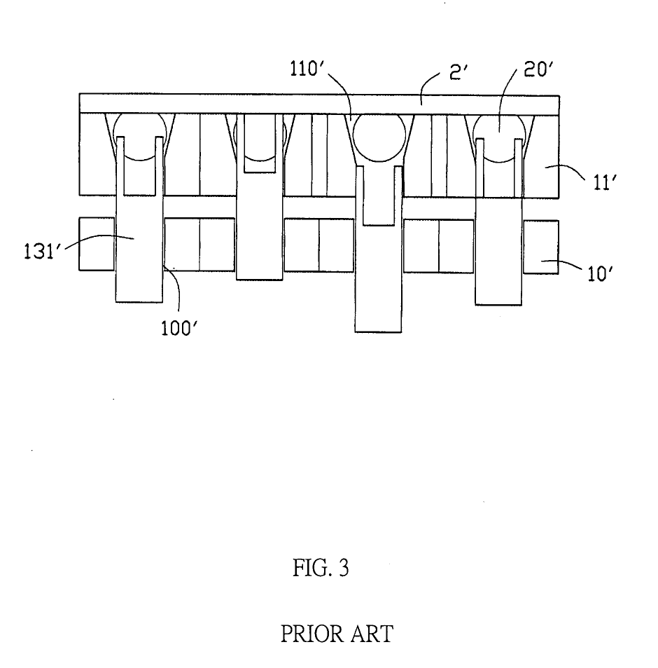

FIG. 4 is an isometric view of an electrical connector assembly receiving a chip module therein in accordance with a preferred embodiment of the invention;

FIG. 5 is an isometric view of a terminal assembled in the electrical connector assembly shown in FIG. 4;

FIG. 6 is a cross-sectional view of the electrical connector assembly shown in FIG. 4 in a direction I-I.

FIG. 7 is a amplified view of circle B shown in FIG. 6.

FIG. 8 is a perspective view of the electrical connector assembly shown in FIG. 7, wherein the contact engaging portion of the terminal contacts with the chip module;

### DETAILED DESCRIPTION OF THE PREFERRED EMBODIMENTS

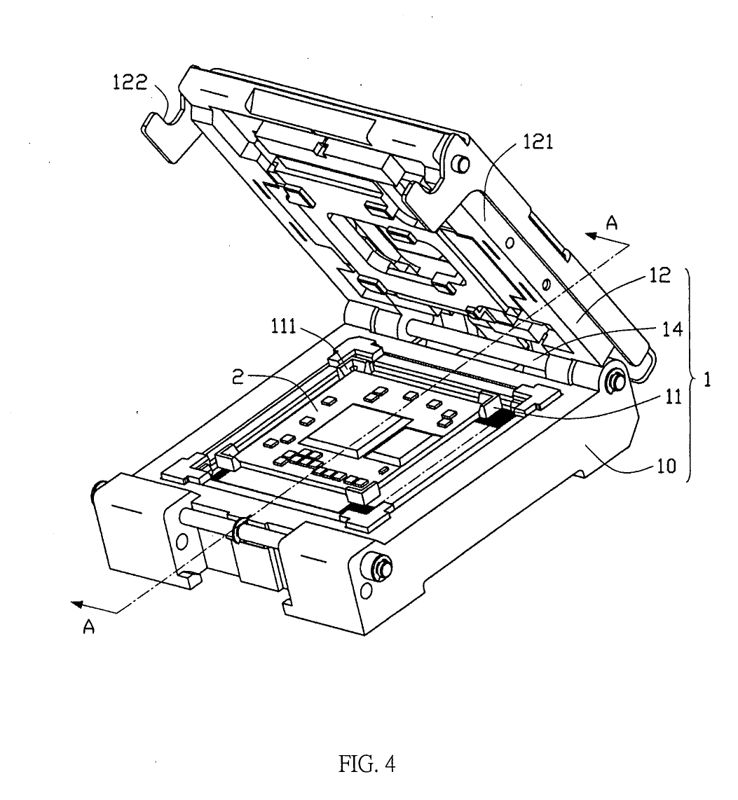

Referring to FIG. 4, an electrical connector assembly 1 comprises a housing 5110, a operating member mounted on the housing 11, a cover 12 pivotally engaged on a side of the housing 11, a shaft 14 for connecting the housing 10 and the cover 12, a plurality of terminals 13.

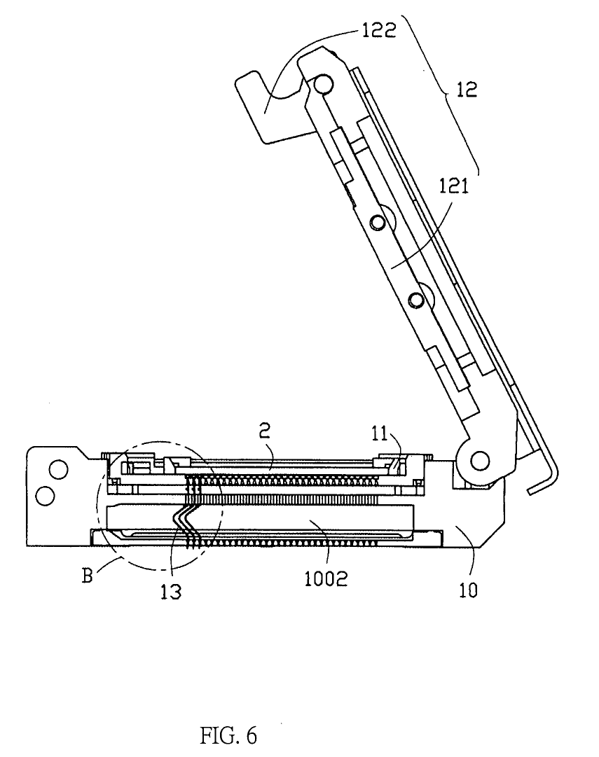

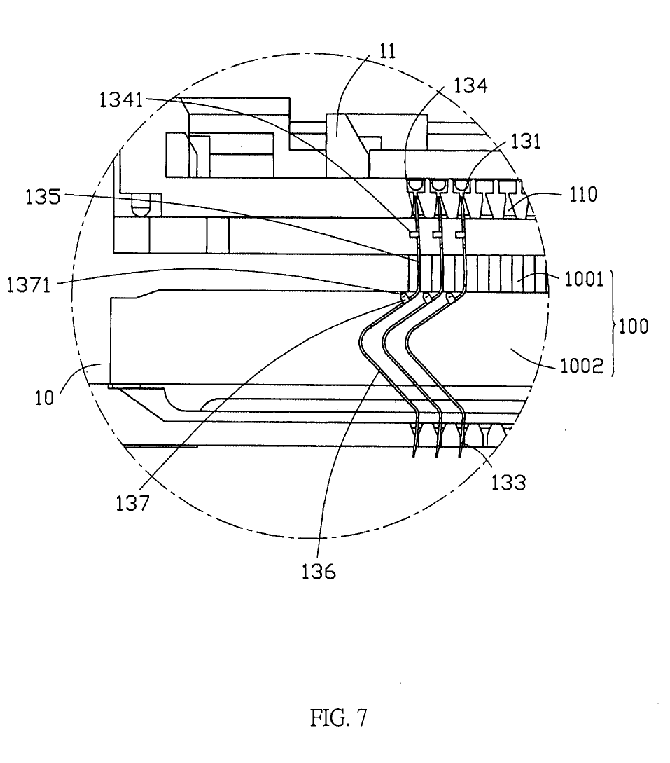

Referring to FIGS. 6-7, the housing 10 is rectangular and defines a plurality of through passageways 100. The passageway 100 comprises a first passageway 1001 disposed on an upper position and a second passageway 1002 disposed on a lower position thereof.

The operating member 11 comprises a locating member 111 in the corner thereof for receiving the chip module 2 thereon and a plurality of receiving slots 110 for receiving the terminals 13.

The rectangular cover 12 comprises a frame 121 and a locking member 122 for locking the cover 12 on the housing 10.

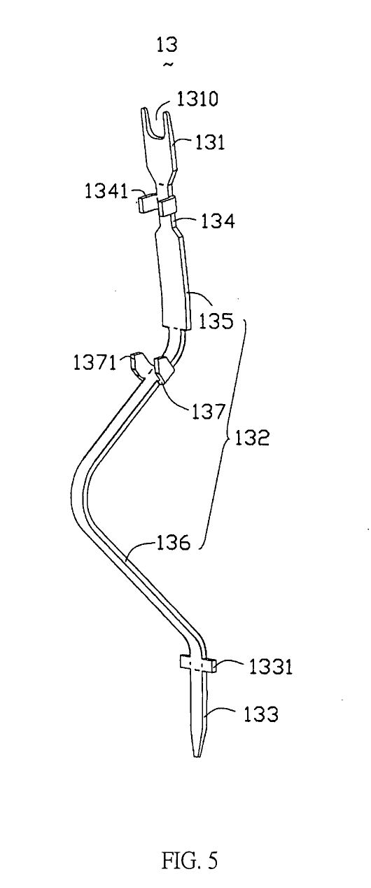

Referring to FIG. 5, the terminal 13 comprises a contact engaging portion 131 received in the receiving slot of the operating member 11, an retaining portion 132, a tail 133 for connecting with the printed circuit board.

The contact engaging portion 131 received in the receiving hole 110 of the operating member 11 is conventionally planar and further comprises an opening 1310 for receiving the solder ball 20 disposed on a lower surface of the chip module 2.

The retaining portion 132 comprises a neck portion 134, a lead-portion 135, an elastic portion 136 received in the second passageway 1002 and a connecting portion 137 for connecting the leading portion 135 and the elastic portion 136. The leading portion 135 is inserted into the first passageways 1001. The elastic portion 136 is C-shaped and inserted into the second passageways 1002 providing an elastic deformation for altering the length of the contact engaging portion 131 inserted into the passageways 100. The connecting portion 137 defines a pair of second projections 1371 for controlling the deformation of the elastic portion, and the projections only move in the second passageways 1002, which can not move into the first passageways.

The tail 133 for connecting with the printed circuit board comprises a third projection 1331 disposed below the second passageways for limiting the movement of the tail 133.

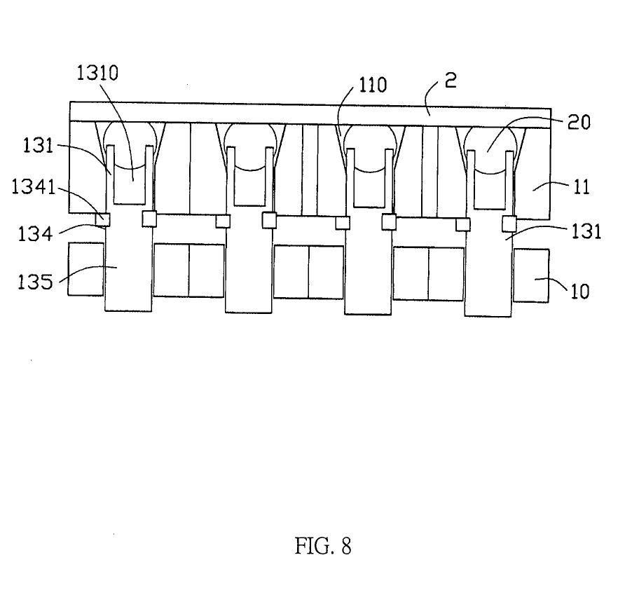

Referring to FIG. 8, the neck portion 134 defines a pair of first projections 1341 and the shape of the first projection 1341 is not limited to rectangular or round shape. The first projection 1341 is disposed between the operating member 11 and the housing 10 for abutting against the operating member 11.

In assembly, the terminals 13 are firstly inserted into the housing 10, at this moment, the contact engaging portion 131 defining the opening 1310 is received in the receiving holes, the first projection 1341 of the first neck portion 134 is disposed between the operating member 11 and the housing 10, the leading portion is received in the first passageways 1001, the second projection 1371 of the elastic portion 136 and the second connecting portion 137 is disposed in the second passageways 1002, the third projection 1331 is disposed below the housing 10. Then, the operating member 11 and the chip module 2 are mounted on the housing 10. The solder balls 20 of the chip module 2 are inserted into the receiving holes 110. Sequentially, the cover 12 is pivotally mounted on the housing 10 and locked on the housing 10 by the locking member 122. When the cover 12 presses the chip module 2 downwardly, the contact engaging portion 122 of terminals 13 is inserted through the passageways 100 and beyond the operating member 11. However, the first projection 1341 disposed on a lower end of the operating member 11 can limit the protruding length of the contact engaging portion 131. The chip module 2 and the terminals 13 can attain a well electrical connection.

It will be understood that the invention may be embodied in other specific forms without departing from the spirit or central characteristics thereof. The present examples and embodiments, therefore, are to be considered in all respects as illustrative and not restrictive, and the invention is not be limited to the details given herein.

What is claimed is:

1. An electrical connector assembly comprising
a housing defining a number of passageways;
a plurality of terminals received in the passageways, each terminal including a containing portion receiving in the passageways of the housing and a contact engaging portion extending beyond a top surface of the housing; and
an operating member mounted on the housing comprising a number of receiving slot in correspondence to the passageways receiving the contact engaging portion therein; wherein
the contact engaging portion defines at least a first projection abutting against a bottom surface of the operating member.

2. The electrical connector assembly as claimed in claim 1, wherein the retaining portion includes a neck portion extending outwardly from the housing and said at least a first projection extends from one or two sides of the neck portion.

3. The electrical connector assembly as claimed in claim 2, further comprising a third projection disposed on two sides of the tail.

4. The electrical connector assembly as claimed in claim 3, wherein the retaining portion further comprises a lead-portion, an elastic portion received in the second passageway and a connecting portion for connecting the leading portion and the elastic portion.

5. The electrical connector assembly as claimed in claim 4, further comprising a second projection disposed on two sides of the connecting portion.

6. An electrical connector assembly comprising
a housing defining a number of passageways;
an operating member mounted on the housing comprising a number of receiving slot in correspondence to the passageways; and
a plurality of terminals received in the housing comprising a contact engaging portion, an retaining portion receiving in the passageways, and a tail for connecting with the printed circuit board; wherein
the retaining portion defines a number of first projections for limiting length of the contact engaging portion inserted into the operating member, and the retaining portion further comprises at least a second projection on lateral sides thereof and the tail defines at least a third projection on sides thereof.

7. An electrical connector assembly comprising
a housing defining a number of passageways;
a plurality of terminals received in the passageways, each terminal including a containing portion receiving in the passageways of the housing and a contact engaging portion extending beyond a top surface of the housing;
an operating member mounted on the housing and comprising a number of receiving slot in correspondence to the passageways receiving the contact engaging portion therein; and
a chip module seated upon the operating member and downwardly pressing the corresponding contact engaging portions; wherein
an interengagement device is formed on at least one of the operating member and the engaging portion of the contact as so to restrain upward movement of the contact relative to the operating member when no chip module is available.
